(19) United States
(12) Patent Application Publication
(10) Pub. No.: US 2026/0357649 A1
(43) Pub. Date: Nov. 12, 2026

(54) STRUCTURE FOR ATTACHING SHEET MEMBER TO WINDOW PANE

(71) Applicant: NAM CORPORATION, Osaka (JP)

(72) Inventor: Nobuyoshi TANAKA, Osaka (JP)

(73) Assignee: NAM CORPORATION, Osaka (JP)

(21) Appl. No.: 19/121,667

(22) PCT Filed: Aug. 4, 2023
(86) PCT No.: PCT/JP2023/028518

§ 371 Date: Apr. 16, 2025

(30) Foreign Application Priority Data
Oct. 24, 2022 (JP) 2022-169594

(51) Int. Cl. E06B 9/24; F16B 5/00

(52) U.S. Cl. CPC E06B 9/24; F16B 5/00; E06B 2009/2417; F16B 2200/83

(57) ABSTRACT

Provided is a structure that is for attaching a sheet member to a window pane and that is capable of neatly attaching the sheet member to a surface of the window pane without causing wrinkles and bubbles to occur, facilitating reattachment, adjusting a shading ratio and a privacy protection position, and the like. The structure comprises: a first magnet piece 2 attached to a surface of a window pane G along stiles F on both sides of a sash S; and a second magnet piece 3 attached to both sides of a sheet member 1, and configured to be attached to the corresponding first magnet piece 2 by magnetism.

### TECHNICAL FIELD

The present invention relates to structures for attaching a sheet member to a surface of a window pane.

### BACKGROUND ART

It is conventionally known that a light blocking sheet may be attached to a window pane of a house, office building, or the like in order to block light or protect privacy (see, for example, Patent Document 1).

Patent Document 1 describes a light blocking sheet in which a polyvinyl chloride resin sheet layer is integrally provided on top of one surface of a polyester film on which a translucent metal vapor deposition film such as an aluminum vapor deposition film is formed, and an adhesive layer having a weak adhesive strength is provided on the polyvinyl chloride resin sheet layer.

Such a light blocking sheet is attached to a window pane by means of the adhesive layer. Therefore, unfortunately, wrinkles are likely to occur in the light blocking sheet during attachment, and bubbles are likely to occur between the window pane and the light blocking sheet during or after attachment. In addition, it is difficult to reattach the sheet, and it is also difficult to adjust the shading ratio of the sheet. In addition, when the sheet is attached for privacy protection, it is not easy to see outside from inside.

### CITATION LIST

### Patent Literature

Patent Document 1: Japanese Utility Model Application Publication No. 57-050341

### SUMMARY OF INVENTION

### Technical Problem

With the above problems in mind, the present invention has been made. It is an object of the present invention to provide a structure that is capable of neatly attaching a sheet member to a surface of a window pane without causing wrinkles and bubbles to occur, facilitating reattachment, adjusting a shading ratio and a privacy protection position, and the like.

### Solution to Problem

To address the above problems, a structure for attaching a sheet member to a window pane according to the present invention is a structure for attaching the sheet member to a surface of the window pane, and comprises:
a first magnet piece or magnetic material piece attached to the surface of the window pane along stiles on both sides of a sash; and
a second magnet piece of magnetic material piece attached to both sides of the sheet member, and configured to be attached to the corresponding first magnet piece or magnetic material piece by magnetism.

In this case, the sheet member may include separate portions configured to be arranged vertically, side by side, with the upper and lower portions overlapping when the sheet member is attached to the surface of the window pane.

In addition, the sheet member may be in the shape of a bag.

In addition, the first and second magnet pieces may have the polarity that alternates at predetermined intervals in a length or width direction thereof.

In addition, the first magnet or magnetic material piece may not be provided at a position of a crescent-type lock keeper.

In addition, the first magnet piece that is not provided at the position of the crescent-type lock keeper may have the polarity that alternates at predetermined intervals in a length direction thereof, and may maintain continuity of the polarities of an upper and a lower portion of said first magnet piece above and below a discontinuous portion.

### Advantageous Effects of Invention

In the structure for attaching a sheet member to a window pane according to the present invention, the first magnet pieces or magnetic material pieces are attached to a surface of the window pane along stiles on both sides of a sash, and the sheet member can be attached to the surface of the window pane by means of the second magnet pieces or magnetic material pieces that are attached to both sides of the sheet member, and are attached to the first magnet pieces or magnetic material pieces by magnetism. As a result, the sheet member can be neatly attached to the surface of the window pane without causing wrinkles and bubbles to occur. In addition, even after the sheet member is once attached, the sheet member can be easily removed and reattached, and the shading ratio and privacy protection position of the sheet member can be easily adjusted, for example.

In addition, the sheet member includes separate portions configured to be arranged vertically, side by side, with the upper and lower portions overlapping when the sheet member is attached to the surface of the window pane. Therefore, the shading ratio and the privacy protection position of the sheet member can be easily adjusted, for example.

In addition, the sheet member may be in the shape of a bag. With this configuration, the sheet member can have a storage function. For example, the bag-shaped sheet member can store things to be displayed such as posters and photographs, and can allow the things to be seen.

In addition, the first and second magnet pieces may have the polarity that alternates at predetermined intervals in a length or width direction thereof. With this configuration, a greater magnetic attachment force can be obtained.

In addition, the first magnet piece or magnetic material piece may not be provided at the position of the crescent-type lock keeper. With this configuration, the sheet member can be attached to a surface of a window pane by means of the second magnet piece or magnetic material piece attached to the sheet member being attached to the first magnet piece or magnetic material piece by magnetism, without interfering with the crescent-type lock keeper.

In addition, the first magnet piece that is not provided at the position of the crescent-type lock keeper may have the polarity that alternates at predetermined intervals in a length direction thereof, and may maintain continuity of the polarities Of an upper and a lower portion of said first magnet piece above and below the discontinuous portion. With this configuration, a more stable magnetic attachment force can be obtained by the first magnet piece.

### BRIEF DESCRIPTION OF DRAWINGS

FIG. 1 is a diagram for describing an example of a structure for attaching a sheet member to a window pane according to the present invention.

FIG. 2 illustrates first magnet pieces and second magnet pieces that are used in the structure for attaching a sheet member to a window pane of FIG. 1. FIG. 2(a) is a diagram for describing first and second magnet pieces having the polarity that alternates at predetermined intervals in a length direction. FIG. 2(b) is a diagram for describing first and second magnet pieces having the polarity that alternates at predetermined intervals in a width direction.

FIG. 3 is a diagram for describing a relationship between first and second magnet pieces used in the structure for attaching a sheet member to a window pane of FIG. 1.

FIG. 4 is a diagram for describing a relationship between a first magnetic piece and a second magnet piece or magnetic material piece used in the structure for attaching a sheet member to a window pane of FIG. 1.

FIG. 5 is a diagram for describing an example of the structure for attaching a sheet member to a window pane of FIG. 1 in which the sheet member is made of a thin synthetic resin film or the like.

FIG. 6 is a diagram for describing an example of the structure for attaching a sheet member to a window pane of FIG. 1 in which the sheet member is in the shape of a bag.

FIG. 7 is a diagram for describing an example of the structure for attaching a sheet member to a window pane of FIG. 1 in which a shadow cutout is provided on top of the sheet member.

FIG. 8 is a diagram for describing an example of the structure for attaching a sheet member to a window pane of FIG. 1 in which a shadow cutout is provided on top of the sheet member.

FIG. 9 is a diagram for describing an example of the structure for attaching a sheet member to a window pane of FIG. 1 in which the structure is applied to a position of a crescent-type lock keeper.

### DESCRIPTION OF EMBODIMENTS

Embodiments of a structure for attaching a sheet member to a window pane according to the present invention will be described below with reference to the accompanying drawings.

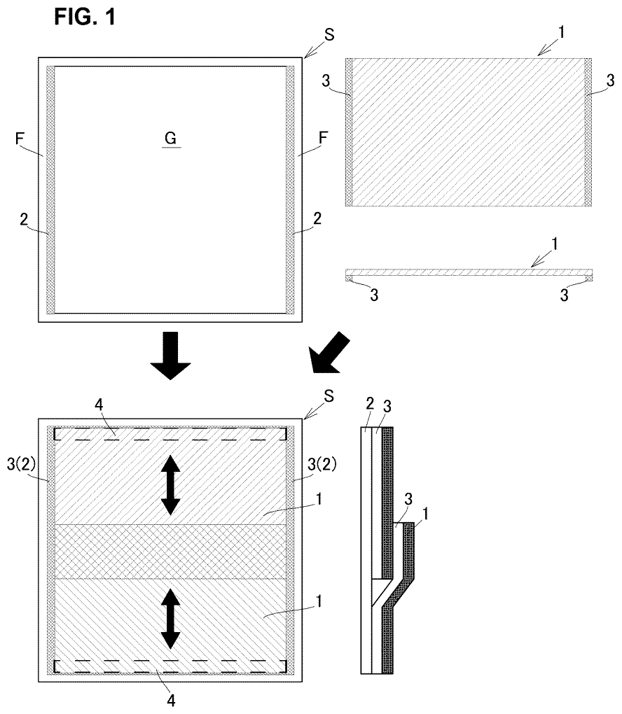

FIG. 1 illustrates an example of a structure for attaching a sheet member to a window pane according to the present invention.

The structure for attaching a sheet member to a window pane is for attaching a sheet member 1 to a surface of a window pane G. The structure includes a first magnet piece 2 that is attached to the surface of the window pane G along stiles F on both sides of a sash S, and a second magnet piece 3 that is attached to both sides of the sheet member 1, and is to be attached to the corresponding first magnet piece 2 by magnetism.

Examples of the window pane G include window panes of houses, office buildings, and other constructions.

In this case, the sheet member 1 may be a single sheet having the Same size as that of the window pane G. Alternatively, there may be a plurality of the sheet members 1, which are separate sheets that are to be arranged vertically, side by side (in this example, there are two sheet members 1 that are separate sheets that are to be arranged vertically, side by side, although there may be three or more sheet members 1) and attached to the surface of the window pane G with the upper and lower separate sheet members 1 overlapping.

The sheet member 1 is opaque or translucent, depending on the purpose such as light blocking or privacy protection. The sheet member 1 preferably has any of a cloth, a nonwoven fabric, and a synthetic resin film, synthetic resin sheet, and synthetic resin plate made of a polyolefin resin, acrylic resin, polycarbonate resin, polystyrene resin, polyvinyl chloride resin, or the like that has any shading ratio. Of them, a cloth and nonwoven fabric are particularly preferable. The cloth and nonwoven fabric may be a mesh sheet. A frosted glass-like pattern or the like may be printed on the synthetic resin film, synthetic resin sheet, and synthetic resin plate to make the film, sheet, and plate translucent. A mesh, dot, check, or stripe pattern or the like may be printed on a portion of the synthetic resin film, synthetic resin sheet, and synthetic resin plate. The color of the sheet member 1 is preferably a light color such as white, pink, cream, or light blue, particularly preferably white. By utilizing such materials and colors, light blocking properties and a privacy protection function are exhibited. Furthermore, when seen from inside of the room during the day, the sheet member 1 entirely appears whitish in color due to the penetrated sunlight. When seen from inside of the room during the night, the sheet member 1 appears blackish such as navy blue or ultramarine blue in color due to an influence of a change in the darkness of the outside. Therefore, the lightness and darkness of the sheet member 1 can appear to be reversed, depending on a difference in lightness between inside and outside of the room. In the case in which the sheet member 1 is made of a white cloth or nonwoven fabric, light can be introduced into a room to the extent that the inside of the room is not too dark. Thus, the sheet member 1 can be used instead of a lace curtain.

The sheet member 1 is configured to have a shading ratio, for example, from 40 to 85%.

Although, in the above embodiment, the sheet member 1 is attached throughout the surface of the window pane G, the size and attachment position of the sheet member 1 are not particularly limited, and may be determined, as appropriate, depending n the range in which light blocking or privacy protection is desired.

In the case in which there are a plurality of sheet members 1 that are separate sheets which are to be arranged vertically, side by side, if the sheet members 1 are attached to the surface of the window pane G with the upper and lower sheet members 1 overlapping, the shading ratio and privacy protection position of the sheet member 1 can be easily adjusted, for example.

The first magnet piece 2 and the second magnet piece 3 may, for example, be a rubber magnet piece having a width of about 5 to 30 mm and a thickness of about 1 to 2 mm. The first magnet piece 2 and the second magnet piece 3 are attached to the window pane G and the sheet member 1 by any fixation means such as an adhesive tape or an adhesive agent.

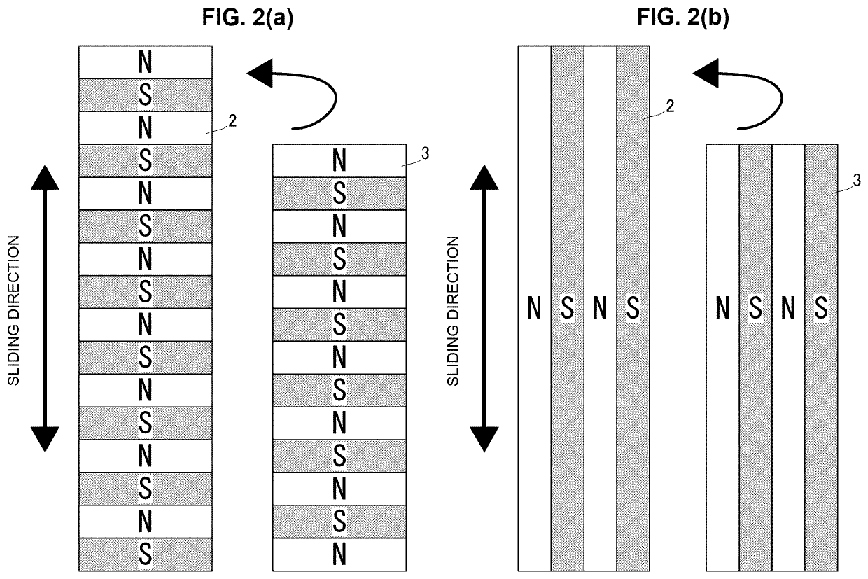

In this case, as illustrated in FIG. 2, the polarity of the first magnet piece 2 and the second magnet piece 3 may preferably alternates at predetermined intervals of, for example, about 1 to 30 mm, preferably about 1 to 10 mm, and more preferably about 2 to 5 mm, in a length direction (FIG. 2(a)) or a width direction (FIG. 2(b)).

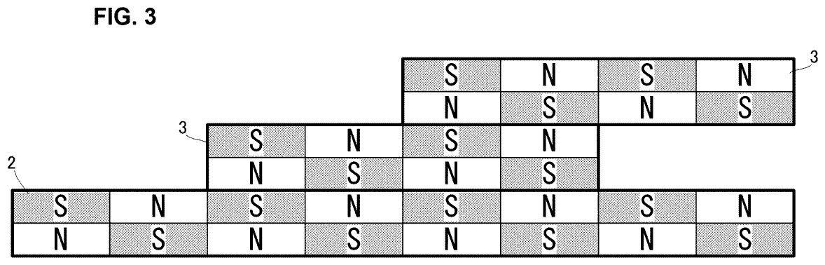

Here, as illustrated in FIG. 3, in the case in which two second magnet pieces 3 are stacked on and attached to a first magnet piece 2 by magnetism, the opposite magnet pieces can be attached together by magnetism at positions having different polarities.

As a result, the first magnet piece 2 and the second magnet piece 3 can be attached together by a great magnetic force. In particular, as illustrated in FIG. 2(a), the polarity of the first magnet piece 2 and the second magnet piece 3 alternates at predetermined intervals in the length direction. Therefore, the sheet member 1 can be repositioned on a (the predetermined interval×2) by (the predetermined interval×2) basis. In addition, in the case in which there are a plurality of sheet members 1 that are separate sheets which are to be arranged vertically, side by side, the magnetic attachment force can be maintained at a portion where the upper and lower separate sheet members 1 Overlap. Alternatively, as illustrated in FIG. 2(b), the polarity of the first magnet piece 2 and the second magnet piece 3 may alternate at predetermined intervals in the width direction. In this case, although the magnetic attachment force is slightly reduced compared to the case of FIG. 2(a), the sheet member 1 can be repositioned continuously or in a non-stepwise manner.

It should be noted that the first magnet piece 2 and the second magnet piece 3 may be made of a ferrite magnet, or alternatively, a neodymium magnet, which has a greater magnetic attachment force, or the like.

The poles of the first magnet piece 2 and the second magnet piece 3 may be displayed, or marked in different colors, by printing or the like in order to allow the user to identify the polarities of the poles.

A space is produce between the window pane G and the sheet member 1 due to the thicknesses of the first magnet piece 2 and the second magnet piece 3. In order to seal the space, a sealing piece 4 may be attached to an upper and a lower end of the sheet member 1 (or the surface of the window pane G along the top and bottom rails of the sash S).

Here, the sealing piece 4 may be made of an insulating material such as a foam resin, or a material similar to that of the first magnet piece 2 and the second magnet piece 3.

As a result, the space produced between the window pane G and the sheet member 1 can serve as an insulating space to prevent occurrence of condensation.

Thus, the first magnet pieces 2 are attached to the surface of the window pane G along stiles F on both sides of the sash S, and the sheet member 1 is attached to the surface of the window pane G by means of the second magnet pieces 3 that are attached to both sides of the sheet member 1, and are to be attached to the first magnet pieces 2 by magnetism. As a result, the sheet member 1 can be neatly attached to the surface of the window pane G without causing wrinkles and bubbles to occur. In addition, even after the sheet member 1 is once attached, the sheet member 1 can be easily removed and reattached, and the shading ratio and privacy protection position of the sheet member 1 can be easily adjusted, for example.

Incidentally, in this example, the first magnet piece 2 and the second magnet piece 3 made of a rubber magnet or the like are used in order to attach the sheet member 1 to the surface of the window pane G. Alternatively, a portion of the first magnet pieces 2 and the second magnet pieces 3 may be substituted for by a magnetic material piece such as an iron plate.

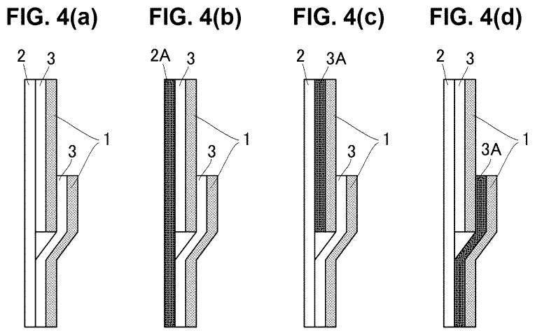

FIG. 4(b) illustrates an example in which a magnetic material piece 2A is used instead of the first magnet piece 2 illustrated in FIG. 4(a). FIGS. 4(c) and 4(d) illustrate examples in which a magnetic material piece 3A is used instead of the second magnet piece 3 illustrated in FIG. 4(a).

Incidentally, in the case in which the sheet member 1 is made of a thin synthetic resin film or the like, the tensile strength of the sheet member 1 is, unfortunately, not sufficient to prevent wrinkles and slackness from occurring in the sheet member 1.

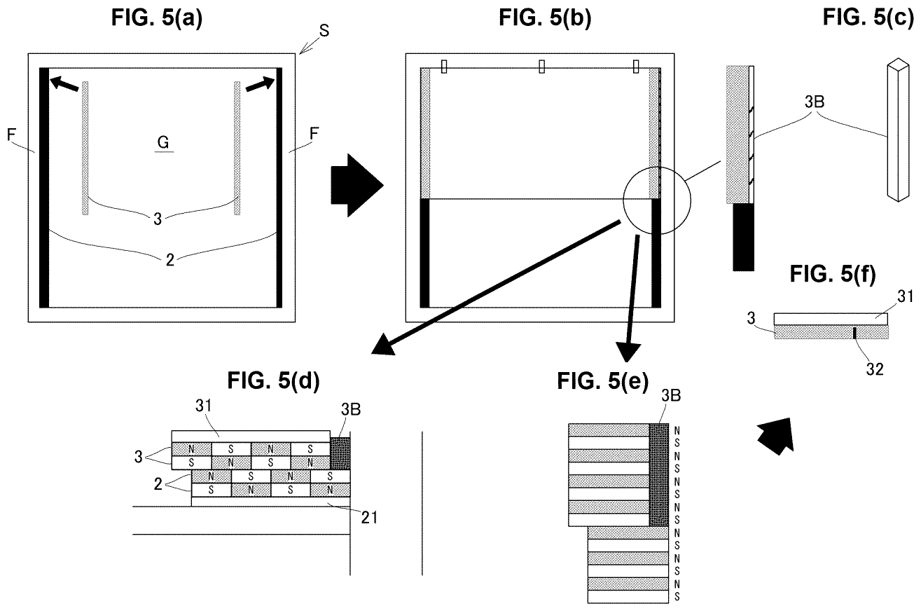

A method for attaching the sheet member 1 so as to address this problem will be described with reference to FIG. 5.

Firstly, as illustrated in FIG. 5(a), the first magnet pieces 2 are attached to a surface of a window pane G along stiles F on both sides of a sash S, and the second magnet pieces 3 attached to both sides of the sheet member 1 are attached to the first magnet pieces 2 by magnetism.

At this time, as illustrated in FIG. 5(b), one of the second magnet pieces 3 is attached further inside with a bar-shaped spacer 3b of square section with a side of several millimeters (see FIG. 5(c)) interposed between that second magnet piece 3 and the stile F.

In this state, the sheet member 1 is attached to the second magnet pieces 3 with the sheet member 1 stretched tight. At this time, if the sheet member 1 is temporarily attached to the top (or bottom) rail of the sash S using an adhesive tape, attachment work can be smoothly performed.

Next, the spacer 3B is removed so that the sheet member 1 is attached to the surface of the window pane G by the second magnet pieces 3 being attached to the first magnet pieces 2 by magnetism.

Thus, as illustrated in FIG. 5(d), in the case in which the first magnet piece 2 and the second magnet piece 3 are configured to have the polarity that alternates at predetermined intervals in the width direction, a magnetic force is applied from the first magnet piece 2 to the second magnet piece 3 so as to move the second magnet piece 3 outward (in the direction of the stile F). As a result, a tensile force is applied to the sheet member 1, so that wrinkles and slackness can be prevented from occurring in the sheet member 1.

On the other hand, as illustrated in FIG. 5(e), in the case in which the first magnet piece 2 and the second magnet piece 3 have the polarity that alternates at predetermined intervals in the length direction, a magnetic force that moves the second magnet piece 3 outward (in the direction of the stile F) as illustrated in FIG. 5(d) is not produced, but a tensile force is applied to the sheet member 1, so that wrinkles and slackness can be prevented from occurring in the sheet member 1.

Alternatively, in the step illustrated in FIG. 5(b), the second magnet piece 3 that is wider than a predetermined width by several millimeters and has a perforated line 32 obtained by previously providing small cuts or the like (see FIG. 5(f)) may be used instead of use of the spacer 3B. The sheet member 1 may be attached to the second magnet pieces 3 with the sheet member 1 stretched tight. Next, the second magnet pieces 3 may be cut along the perforated line 32 into the predetermined size, so that the sheet member 1 is attached to the surface of the window pane G by the second magnet pieces 3 being attached to the first magnet pieces 2 by magnetism.

It should be noted that, in FIGS. 5(d) and 5(f), the first magnet piece 2 and the second magnet piece 3 are attached to the window pane G or the sheet member 1 by means of adhesive layers 21 and 31, respectively.

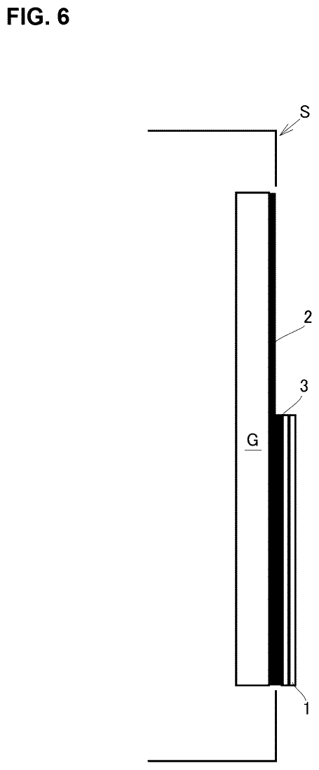

Alternatively, as illustrated in FIG. 6, in the structure for attaching a sheet member to a window pane according to the present invention, the sheet member 1 may be formed of a bag-shaped synthetic resin film, synthetic resin sheet, or synthetic resin plate.

Specifically, the sheet member 1 may, for example, be in the shape of a bag having an opening at the top thereof. The sheet member 1 may be attached to a surface of a window pane G by the second magnet pieces 3 being attached to the first magnet pieces 2.

As a result, the sheet member 1 can have a storage function. For example, the bag-shaped sheet member 1 can store things to be displayed such as posters and photographs, and can allow the things to be seen from inside of the room (or from outside of the room).

In the case in which things to be displayed such as posters and photographs are stored in the bag-shaped sheet member 1, at least a side of the sheet member that is to be displayed may be made of a transparent synthetic resin film, synthetic resin sheet, or synthetic resin plate.

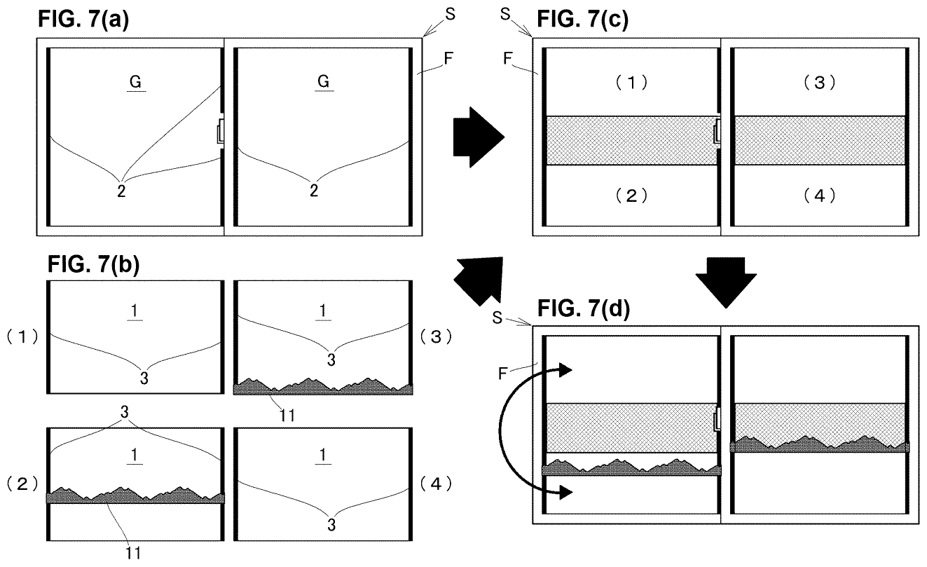

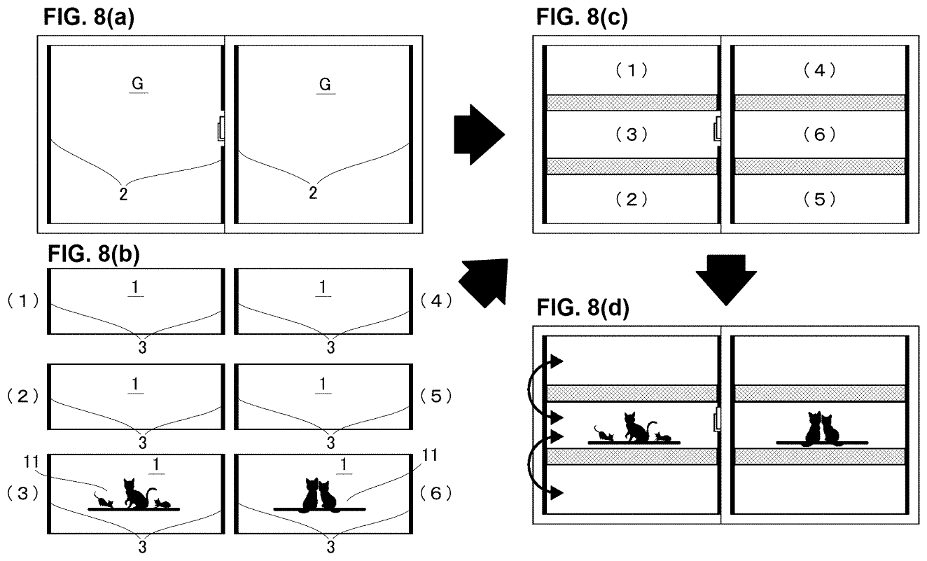

In addition, as illustrated in FIGS. 7 and 8, in the structure for attaching a sheet member to a window pane according to the present invention, design properties of a shadow cutout can be imparted to the sheet member 1, for example.

Specifically, firstly, as illustrated in FIGS. 7(a) and 8(a), the first magnet piece 2 is attached to a surface of a window pane G along stiles F on both sides of a sash S.

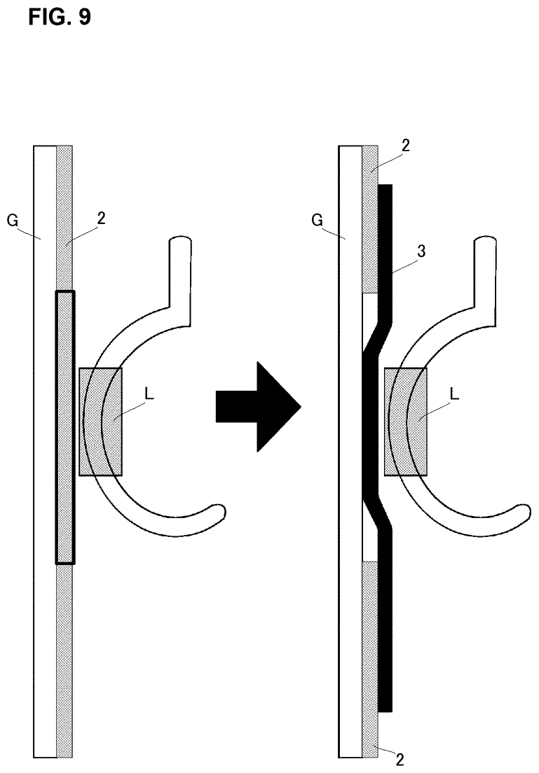

Here, as illustrated in FIG. 9, the first magnet piece 2 may not be provided at a position of a crescent-type lock keeper L, so that the second magnet piece 3 does not interfere with the crescent-type lock keeper L.

The reason for this is as follows. The crescent-type lock keeper L is attached to a stile F (outer-sash meeting stile) of the sash S. The space between the surface of the window pane G and the crescent-type lock keeper L at the attached position is typically as narrow as several millimeters. Therefore, the first magnet piece 2 and the second magnet piece 3 cannot be simultaneously present at the attached position. If the first magnet piece 2 has a discontinuous portion at the position of the crescent-type lock keeper L, the sheet member 1 can be attached to the surface of the window pane G by means of the second magnet piece 3 being attached to the first magnet piece 2 attached to the sheet member 1 by magnetism, without interfering with the crescent-type lock keeper L.

In the case in which the first magnet piece 2 has the polarity that alternates at predetermined intervals in the length direction, the first magnet piece 2 is attached to the surface of the window pane G along the full length of stiles F on both sides of the sash S, and thereafter, the first magnet piece 2 is partially cut and removed at the position of the crescent-type lock keeper L. As a result, the continuity of the polarity of the upper and lower first magnet pieces 2 above and below the discontinuous portion can be maintained, and therefore, the first magnet piece 2 can provide a stable magnetic attachment force.

As illustrated in FIG. 7(b), in the sheet member 1, four sheets (1) to (4) are used (a shadow cutout 11 is provided on the sheets (2) and (3) of the four sheets), or as illustrated in FIG. 8(b), six sheets (1) to (6) are used (a shadow cutout 11 is provided on the sheets (3) and (6) of the six sheets), and a second magnet piece 3 that is attached to a first magnet piece 2 by magnetism is attached to both sides of each sheet member 1. The sheet members 1 may, for example, be arranged at positions indicated by FIGS. 7(c) and 8(c) (the arrangement of the sheet members may be changed as appropriate). a result, as illustrated in FIGS. 7(d) and 8(d), the sheet members 1 may be attached to a window pane G by the second magnet pieces 3 being attached to the first magnet pieces 2 by magnetism.

Here, the shadow cutout 11 is provided on top of a portion of the sheet member 1. The shading ratio of the shadow cutout 11 is higher than that of the sheet member 1, and is preferably at least 90%, more preferably at least 95%, and particularly preferably at least 98%.

The shadow cutout 11 is in the shape of a picture, graphic, pattern, and/or character. Specifically, examples of the shape include pictures of a human, animal, plant, and the like, graphics of a circle, star, heart, and the like, and patterns of a check, stripe, and the like. The shape of the shadow cutout 11 may not be previously determined, and the user may cut the shadow cutout 11 into their preferred shapes. Because the shadow cutout 11 has such a shape, design properties can be easily improved. In addition, the shape, position, and combination of the shadow cutout 11 can be freely changed, depending on the size of a window or an individual's preference, resulting in an improvement in design flexibility.

The shadow cutout 11 is provided on top of a portion of the sheet member 1. Therefore, the sheet member 1 and the shadow cutout 11, when irradiated with sunlight of about 10,000 to 100,000 lux during the day, appear whitish and dark gray or black, respectively, in color. Therefore, for example, design properties of a shadow cutout can be obtained. The penetrated sunlight becomes gradually weaker from the evening, and therefore, the color of the sheet member 1 appears to change from the daytime whitish color to a bluish color. The original color (e.g., white) of the shadow sheet 11 starts appearing. During the night, the inside of a room has an illuminance of about 1000 lux and is lighter than the outside, and therefore, the original color (e.g., white) of the shadow cutout 11 clearly appears. The color of the sheet member 1 appears to change to navy black, ultramarine black, or dark gray which is close to black, depending on a change in the darkness of the outside of the room. In this embodiment, the sheet member 1 is made of a white, thin nonwoven fabric, and therefore, appears to be a white mist. Thus, the lightness and darkness of the sheet member 1 and the shadow cutout 11 can appear to be reversed, depending on a difference in lightness between inside and outside of the room.

When seen from outside of the room, the lightness and darkness of the sheet member 1 and the shadow cutout 11 appear to be reversed compared to when seen from inside of the room. When seen from outside of the room during the day, the sheet member 1 appears dark gray or black in color while the shadow cutout 11 appears whitish in color. When seen from outside of the room during the night, the sheet member 1 appears whitish in color while the shadow cutout 11 appears dark gray or black in color. Therefore, for example, design properties that provide figures in shadow cutout can be perceived from outside of the room.

In the foregoing, a structure for attaching a sheet member to a window pane according to an embodiment. of the present invention has been described. The present invention is not limited to the configurations described in the above embodiment. Changes and modifications can be made to the configurations as appropriate without departing from the spirit and scope of the present invention.

### INDUSTRIAL APPLICABILITY

The structure for attaching a sheet member to a window pane according to the present invention is capable of neatly attaching a sheet member to a surface of a window pane without causing wrinkles and bubbles to occur, facilitating reattachment, adjusting a shading ratio and a privacy protection position, and the like, and therefore, can be widely used in applications in which a sheet member is attached to a window pane.

REFERENCE SIGNS LIST
1 SHEET MEMBER
11 SHADOW CUTOUT
2 FIRST MAGNET PIECE
2A MAGNETIC MATERIAL PIECE
3 SECOND MAGNET PIECE
3A MAGNETIC MATERIAL PIECE
3B SPACER
21 ADHESIVE LAYER
31 ADHESIVE LAYER
4 SEALING PIECE
F STILE
G WINDOW PANE
L CRESCENT-TYPE LOCK KEEPER
S SASH

1. A structure for attaching a sheet member to a window pane, wherein
the structure is a structure for attaching the sheet member to a surface of the window pane, and
the structure comprises:
a first magnet piece or magnetic material piece attached to the surface of the window pane along stiles on both sides of a sash; and
a second magnet piece or magnetic material piece attached to both sides of the sheet member, and configured to be attached to the corresponding first magnet piece or magnetic material piece by magnetism.

2. The structure for attaching a sheet member to a window pane according to claim 1, wherein
the sheet member includes separate portions configured to be arranged vertically, side by side, with the upper and lower portions overlapping when the sheet member is attached to the surface of the window pane.

3. The structure for attaching a sheet member to a window pane according to claim 1, wherein
the sheet member is in the shape of a bag.

4. The structure for attaching a sheet member to a window pane according to claim 1, wherein
the first and second magnet pieces have the polarity that alternates at predetermined intervals in a length direction thereof.

5. The structure for attaching a sheet member to a window pane according to claim 1, wherein
the first and second magnet pieces have the polarity that alternates at predetermined intervals in a width direction thereof.

6. The structure for attaching a sheet member to a window pane according to claim 1, wherein
the first magnet or magnetic material piece is not provided at a position of a crescent-type lock keeper.

7. The structure for attaching a sheet member to a window pane according to claim 6, wherein
the first magnet piece that is not provided at the position of the crescent-type lock keeper has the polarity that alternates at predetermined intervals in a length direction thereof, and maintains continuity of the polarities of an upper and a lower portion of said first magnet piece above and below a discontinuous portion.

8. The structure for attaching a sheet member to a window pane according to claim 2, wherein
the sheet member is in the shape of a bag.

9. The structure for attaching a sheet member to a window pane according to claim 2, wherein
the first and second magnet pieces have the polarity that alternates at predetermined intervals in a length direction thereof.

10. The structure for attaching a sheet member to a window pane according to claim 2, wherein
the first and second magnet pieces have the polarity that alternates at predetermined intervals in a width direction thereof.

11. The structure for attaching a sheet member to a window pane according to claim 2, wherein
the first magnet or magnetic material piece is not provided at a position of a crescent-type lock keeper.

12. The structure for attaching a sheet member to a window pane according to claim 11, wherein
the first magnet piece that is not provided at the position of the crescent-type lock keeper has the polarity that alternates at predetermined intervals in a length direction thereof, and maintains continuity of the polarities of an upper and a lower portion of said first magnet piece above and below a discontinuous portion.
